(19) United States
(12) Patent Application Publication
(10) Pub. No.: US 2024/0411489 A1
(43) Pub. Date: Dec. 12, 2024

(54) COMPUTER-READABLE RECORDING MEDIUM, PRINT JOB MANAGEMENT SYSTEM, AND PRINT JOB MANAGEMENT METHOD

(71) Applicant: KONICA MINOLTA, INC., Tokyo (JP)

(72) Inventor: Taisuke Minemura, Okazaki-shi (JP)

(73) Assignee: KONICA MINOLTA, INC., Tokyo (JP)

(21) Appl. No.: 18/735,365

(22) Filed: Jun. 6, 2024

(30) Foreign Application Priority Data
Jun. 8, 2023 (JP) 2023-094795

(51) Int. Cl. G06F 3/12

(52) U.S. Cl. CPC G06F 3/1207; G06F 3/1259

(57) ABSTRACT

Disclosed is a non-transitory computer-readable recording medium storing a printing job management program for causing a computer to manage print jobs related to ordered print products. The program causes the computer to execute: a first step of displaying a plurality of print jobs under management on a display part in a form of a list including a current step of each print job; a second step of displaying on the list displayed in the display part, in response to completion of a current step of a print job being input, a name of a next step of the print job and a state that the next step is performable; and a third step of rearranging display of the print job in which the next step is performable based on a print job sequence rule that is registered in advance.

### BACKGROUND OF THE INVENTION

### Technical Field

The present invention relates to a computer-readable recording medium, a print job management system, and a print job management method.

### Description of Related Art

Conventionally, a printing company generally visualizes the status of each print job using a “whiteboard”, a “table or list output on paper”, or the like to manage the progress and workers. However, there are problems with accuracy and timeliness of information, and work errors are likely to occur.

In view of the above, various techniques have been proposed to reduce work errors of workers in printing companies. For example, JP 2007-265216A describes that an operator is notified of from where to where to move a print product in response to a notification about starting a step (production step) related to a print job.

However, with the technology described in JP 2007-265216A, it is difficult for a worker to accurately grasp, in each step, which jobs are on standby in an executable state and which job should be started first (execution order).

### SUMMARY OF THE INVENTION

It is an object of the present invention is to enable an operator to accurately grasp waiting jobs in a state in which an operation can be executed and an execution order of the jobs in each step of a print job.

To achieve at least one of the abovementioned objects, according to an aspect of the present invention, a non-transitory computer-readable recording medium reflecting one aspect of the present invention stores a printing job management program for causing a computer to manage print jobs related to ordered print products, wherein
the program causes the computer to execute:
   a first step of displaying a plurality of print jobs under management on a display part in a form of a list including a current step of each print job;
   a second step of displaying on the list displayed in the display part, in response to completion of a current step of a print job being input, a name of a next step of the print job and a state that the next step is performable; and
   a third step of rearranging display of the print job in which the next step is performable based on a print job sequence rule that is registered in advance.

To achieve at least one of the abovementioned objects, according to another aspect of the present invention, a print job management system, comprises: a server that manages a print job related to an ordered print product; and a terminal device that is connected to the server, wherein
the server:
   causes a terminal device to display a plurality of print jobs under management in a form of a list including a current step of each print job;
   in response to receiving an input of completion of a current step of a print job from the terminal device, displays on the list displayed on the terminal device a name of a next step of the print job and a state that the next step is performable; and
   rearranges display of the print job in which the next step is performable based on a print job sequence rule that determines an order of performing print jobs and is registered in advance.

To achieve at least one of the abovementioned objects, according to another aspect of the present invention, a print job managing method causes a computer to manage print jobs related to ordered print products, wherein
the method causes the computer to execute:
   displaying a plurality of print jobs under management on a display part in a form of a list including a current step of each print job;
   displaying on the list displayed in the display part, in response to completion of a current step of a print job being input, a name of a next step of the print job and a state that the next step is performable; and
   rearranging display of the print job in which the next step is performable based on a print job sequence rule that determines an order of performing print jobs and is registered in advance.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a diagram illustrating an example of the overall configuration of a print job management system;

FIG. 2 is a block diagram illustrating the functional configuration of a management server;

FIG. 3 is a diagram illustrating an example of data storage in an order information DB;

FIG. 4 is a diagram illustrating a data storage example in a progress DB;

FIG. 5 is a diagram illustrating an example of data storage in an order rule DB;

FIG. 6 is a diagram illustrating an example of data storage in a worker DB;

FIG. 7 illustrates an example of a worker setting screen;

FIG. 8A illustrates an example of a job management screen (all steps);

FIG. 8B illustrates an example of a job management screen (assigned step);

FIG. 9 illustrates an example of a job management screen for mobiles;

FIG. 10 is a flowchart illustrating an order information registration processing executed by a controller of FIG. 2;

FIG. 11 is a flowchart illustrating a display update processing executed by the controller of FIG. 2;

FIG. 12 is a flowchart illustrating a work step management processing executed by the controller of FIG. 2;

FIG. 13A is a diagram illustrating an example of a change of the progress information in the work step management processing in a case where the job type is catalog; FIG. 13B is a diagram illustrating an example of a change of the job management screen in accordance with the change of the progress in FIG. 13A;

FIG. 14A is a diagram illustrating an example of a change of the progress information in the work step management processing in a case where the job type is a flyer; FIG. 14B is a diagram illustrating an example of a change of the display of the job management screen in accordance with the change of the progress in FIG. 14A;

FIG. 15A is a diagram illustrating an example of changes of the progress information in the work step management processing in a case where the job type is catalog and the sequence rule is “earlier due date”-“larger number of remaining steps”; FIG. 15B is a diagram illustrating an example of a change of the display of the job management screen in accordance with the change of the progress in FIG. 15A;

FIG. 16A is a diagram illustrating a job management screen for an experienced worker in a case where the status of proofreading has been changed to completed in a job whose job type is catalog; FIG. 16B is a diagram illustrating the job management screen for a freshman worker in a case where the status of proofreading has been changed to completed in a job whose job type is catalog;

FIG. 17A is a diagram illustrating the job management screen for all steps when the parent job is being inspected; FIG. 17B is a diagram illustrating the job management screen for all steps when completion of the inspection of the parent job is input; and

FIG. 18 illustrates an example of a progress screen with respect to each delivery company.

### DETAILED DESCRIPTION

Hereinafter, an embodiment of the present invention is described below with reference to the drawings. However, the embodiments described below have various limitations which are technically preferable for carrying out the present invention. Therefore, the technical scope of the present invention is not limited to the following embodiments and illustrated examples.

### [Configuration of Print Job Management System]

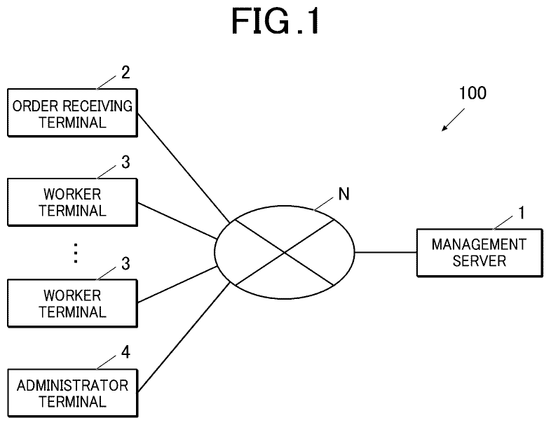

FIG. 1 illustrates an example of the overall structure of a print job management system 100 in the present embodiment. The print job management system 100 is a system installed in a printing company, in particular, a printing company that mainly handles on-demand printing. As illustrated in FIG. 1, the printing job management system 100 includes a management server 1, an order reception terminal 2, a worker terminal 3, and an administrator terminal 4. The order reception terminal 2, the worker terminal 3, and the administrator terminal 4 are connectable to the management server 1 via a communication network N such as a local area network (LAN). The number of each type of terminal is not particularly limited.

The management server 1 manages a job (print job) related to received orders for print product.

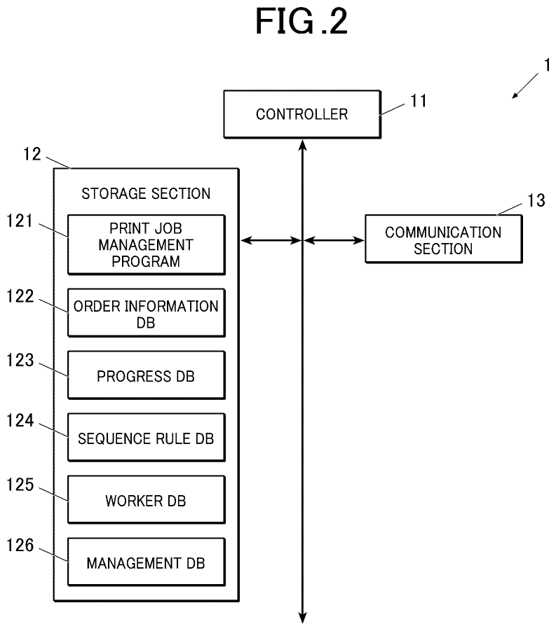

As shown in FIG. 2, the management server 1 includes a controller 11, a storage section 12, a communication section 13, and the like.

The controller 11 includes at least one central processing unit (CPU), a random access memory (RAM), and the like. The CPU of the controller 11 reads a system program or a print job management program 121 stored in the storage section 12, develops the program in the RAM, and executes various processes including a work step management processing to be described later in cooperation with the developed program.

The storage section 12 includes a non-volatile semiconductor memory and a hard disk drive (HDD).

The storage section 12 stores a system program for the management server 1, various processing programs including a print job management program 121, data necessary for executing the programs, and the like.

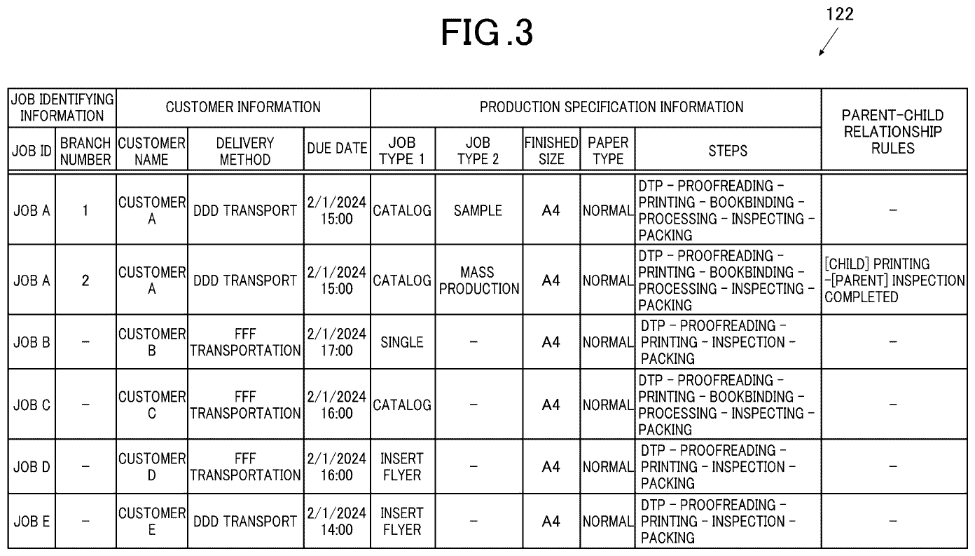

The storage section 12 stores an order information database (DB) 122. As illustrated in FIG. 3, job identification information, customer information, production specification information, parent-child relationship rule, and the like of the job related to the print product of the received order are associated with the job and stored in the order information DB 122 as the order reception information.

The job identification information is information for managing a job related to the print product of the order received by a printing company. The job identification information includes a job ID and a branch number. The job ID is ID information allocated to a job for managing the job related to the print product of the received order. The branch number is an identification number assigned to each of a plurality of jobs in a case where the received job includes the plurality of jobs having a parent-child relationship. In the present embodiment, the smallest number is allocated to the parent job. Jobs having a parent-child relationship are jobs that have at least the same orderer (customer) and are associated with an execution order and timing. In the present embodiment, it is assumed that jobs having a parent-child relationship are jobs having a stop condition for a child job, that is, the child job cannot execute a certain step B until a parent job completes a certain step A.

The customer information includes a customer name, a delivery method, a delivery date, and the like. The customer name is the name of the orderer of the print product of the received order. The delivery method is information indicating a delivery method for the print product of the received order. In the present embodiment, the delivery method is described by the name of a delivery company used for delivery. The delivery date is information indicating the delivery date of the print product of the received order.

The production specification information is information indicating production specifications of the print product of the received order. The production specification information includes a job type 1, a job type 2, a finished size, a paper type, and a steps, and the like. The job type 1 is, for example, information indicating the type of print product to be produced by the job, such as a catalog, a flyer, or a single sheet. The job type 2 is, for example, information indicating whether a print product to be produced by a job is a sample print product or a mass production print product. The steps are production steps necessary for producing the ordered print product. The steps includes, for example, DTP-proofreading-printing-bookbinding-processing-inspection-packing, and the like. In addition, the production specification information may include the number of prints, a product name, and the like.

The parent-child relationship rule is information indicating a rule applied to a job having a parent-child relationship. In the present embodiment, the parent-child relationship rule defines a step having a stop condition for a child job and a step of a parent job serving as a cancellation condition for the stop condition of the child job. For example, “[child] printing-[parent] inspection & completion” illustrated in FIG. 3 indicates that the printing step of the child job is not started until the inspection step of the parent job is completed.

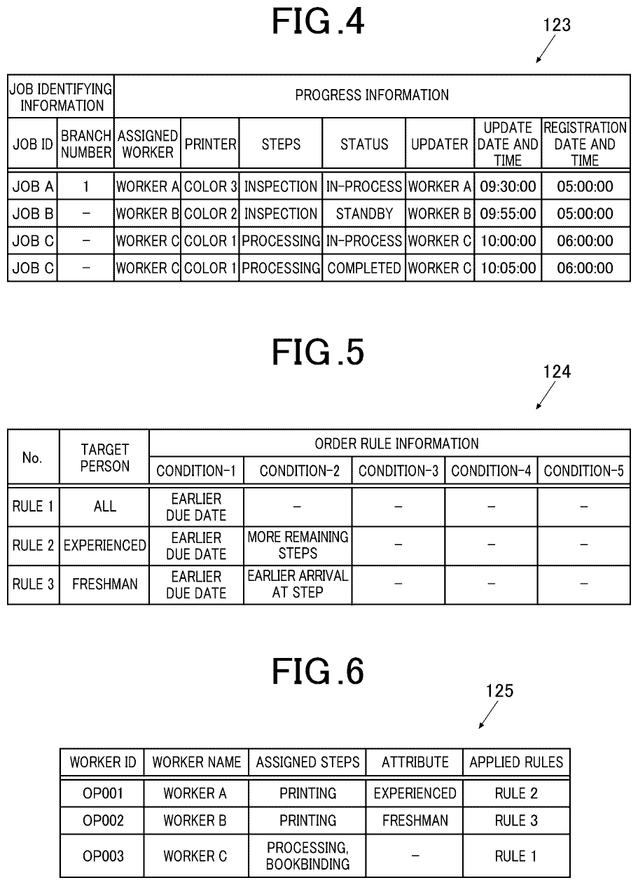

The storage section 12 stores a progress DB 123. As illustrated in FIG. 4, in the progress DB 123, job identification information and progress information of each ordered and registered job are stored in association with the job.

The job identification information includes a job ID and a branch number as described above.

The progress information includes an assigned worker, a printer used, a step, a status, an updater, a date and a time of update, and a date and time of registration. The step is information indicating the current step of the job. The status is information indicating the status of the current step. The status can be, for example, standby, in process, completion, and the like.

The storage section 12 stores a sequence rule DB 124. In the sequence rule DB 124, a sequence rule (printing job starting order rule) registered by the administrator is stored. As illustrated in FIG. 5, a number, a target person, and sequence rule information are stored in association with each other in the sequence rule DB 124.

The number is a number for identifying a rule (rule 1, rule 2, rule 3, and the like).

The target person is information indicating an attribute of target persons to which the rule is applied, and the examples thereof include, for example, all, experienced, freshman, and the like.

The sequence rule information (priority rule information) is information indicating a rule for determining the order of executing jobs in a case where a plurality of jobs are standby for work in the same step. The sequence rule information includes, for example, Condition-1, Condition-2, Condition-3, Condition-4, and Condition-5. Condition-1 to Condition-5 are conditions for sorting, which constitutes the sequence rule. Condition-1 or a combination of two or more of Condition-1 to Condition-5 serves as the sequence rule. The sequence order sorting conditions include, for example, earlier due date, larger number of remaining steps, earlier arrival at the step, and the like.

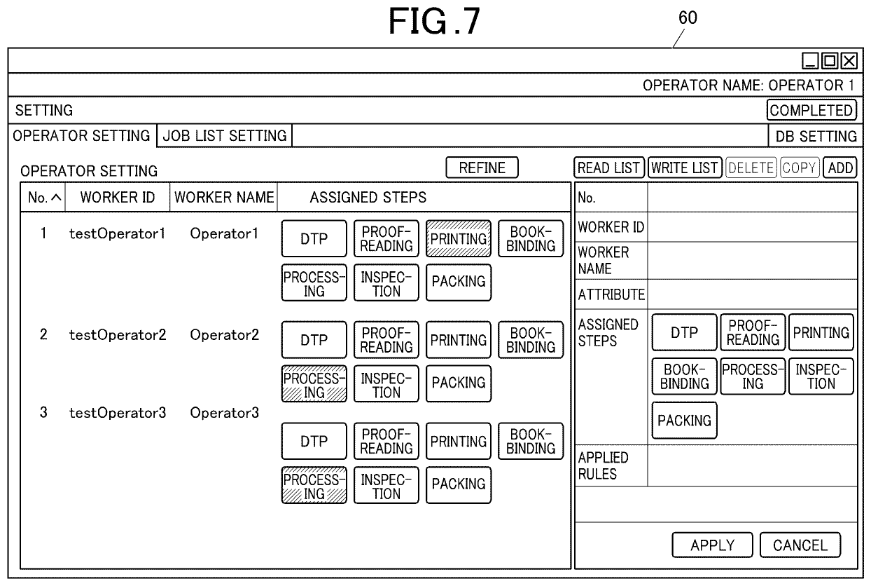

The storage section 12 stores a worker DB 125. in the worker DB125, as illustrated in FIG. 6, worker information such as a worker ID, a worker name, an assigned step, an attribute, and an applied rule is stored. The worker ID is identification information of a worker. The assigned step is information indicating a step that the worker can be assigned to. The attribute is information indicating whether the worker is experienced, a freshman, or others. The applied rule is information of the number of the sequence rule applied to the workers with the attribute. The worker information can be set and changed by the administrator on, for example, a worker setting screen 60 illustrated in FIG. 7.

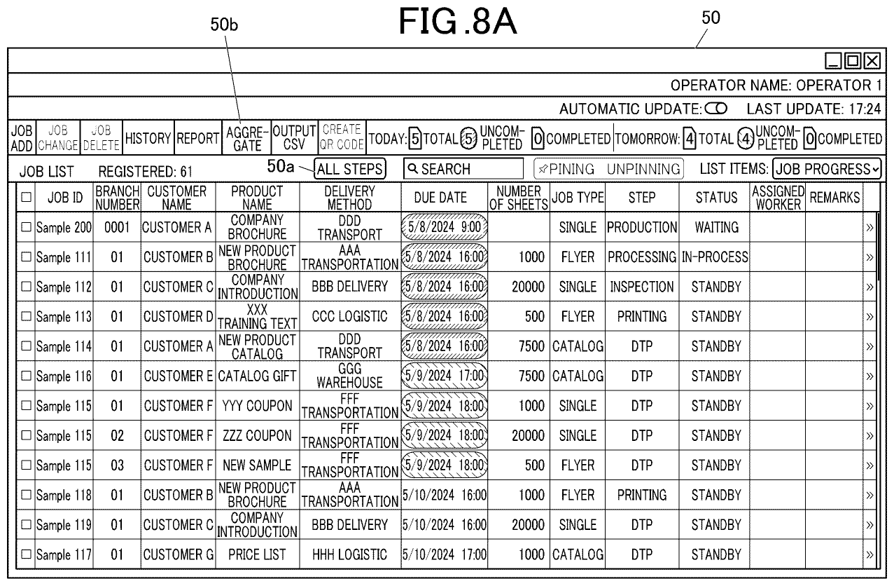

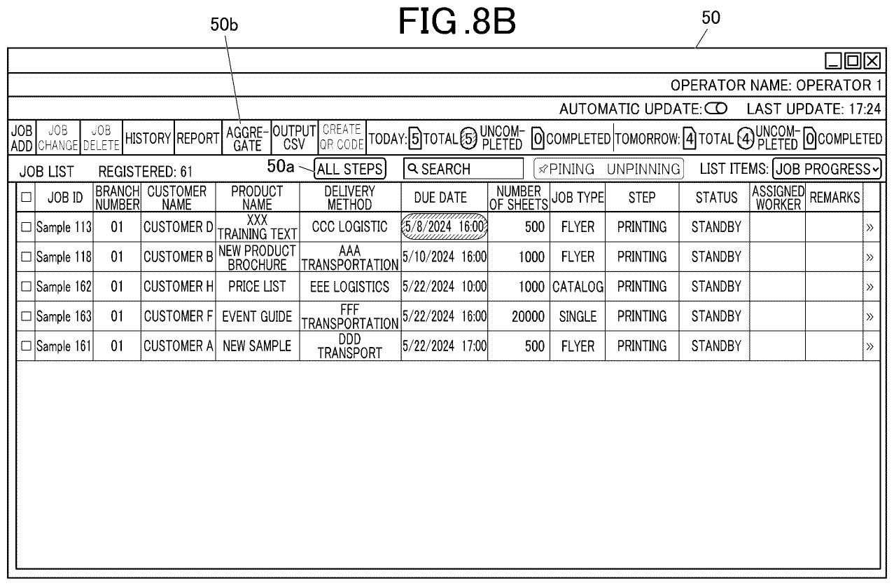

The storage section 12 stores a management DB 126. The management DB 126 stores job management information including a job ID, a branch number, a customer name, a delivery method, a due date, the number of sheets to be printed, a printer to be used, a step, a status, and an assigned worker. The job management information includes items to be displayed on a job management screen 50 (see FIG. 8A). The job management information may include other items such as a product name and the number of sheets to be printed. The step, the status, and the person in charge of the job management information indicate the current step, the current status, and the current assigned worker, respectively.

In addition, the storage section 12 stores login information (a user ID, a password, and the like), a user name, presence or absence of administrative right, and the like of users (an administrator, a worker, or a receptionist) registered in the print job management system 100. The user ID is used as a worker ID or an administrator ID.

The communication section 13 performs communication control for communicating with the order reception terminal 2, the worker terminal 3, and the administrator terminal 4 via the communication network N in a wired or wireless manner.

The order reception terminal 2 is a terminal device for registering information on orders from the orderer in the management server 1. For example, the order reception terminal 2 receives, from the orderer, input of information on each item of the order information DB 122 illustrated in FIG. 3 related to the ordered print product, and transmits the input order information to the management server 1. As the order reception terminal 2, for example, a tablet terminal, a personal computer (PC), a smartphone, or the like can be applied.

The worker terminal 3 is a terminal device (display part) for a worker who performs each step of a job to confirm information and the progress status of the job related to an ordered print product and to input progress information of the job. As the worker terminal 3, for example, a tablet terminal, a personal computer (PC), a smartphone, or the like can be applied.

The administrator terminal 4 is a terminal device (display part) for an administrator who manages a job to check information and the progress status of a job related to an ordered print product, and to register worker information or a sequence rule. As the administrator terminal 4, for example, a tablet terminal, a personal computer (PC), a smartphone, or the like can be applied.

### [Operation of Print Job Management System]

Next, the operation of the print job management system 100 in the present embodiment will be described.

The controller 11 of the management server 1 executes the following processing in cooperation with the printing job management program 121.

When the controller 11 of the management server 1 receives a login request from the order reception terminal 2, the worker terminal 3, or the administrator terminal 4 via the communication unit 13, the control unit 11 performs login authentication. The controller 11 stores and manages the terminal ID of the terminal device and the ID of the login user (operator ID, administrator ID, and the like) in the RAM, the storage section 12, or the like while the device is logged in.

Upon receiving a request to display the job management screen 50 from the worker terminal 3 or the administrator terminal 4 via the communicator 13, the controller 11 causes the terminal 3 or 4 that has sent the request to display the job management screen 50 based on the job management information stored in the management DB 126. The job management screen 50 is a screen for displaying a plurality of jobs to be managed in the form of a list including the current step of each job.

For example, a web browser is installed in each of the worker terminal 3 and the administrator terminal 4, and the web browser requests the management server 1 to display the job management screen 50. The management server 1 has a printing job management program 121, which is a Web app for job management, and displays a job management screen 50 on the display part of the worker terminal 3 or the administrator terminal 4 based on a request from the Web browser thereof.

FIGS. 8A and 8B are views illustrating examples of a job management screen 50. FIG. 8A is an example of a job management screen 50 on which job management information on all steps is listed. FIG. 8B is an example of a job management screen 50 on which job management information on steps (assigned steps) that can be assigned to a logged-in user of a terminal device who has made a request to display the job management screen 50, which is displayed in the form of a list.

The job management screen 50 includes a switch button 50a. The switch button 50a is a button for switching a display target between all steps and assigned steps. When all the steps are displayed, “all steps” is displayed on the switch button 50a. When the switch button 50a is pressed in this state, the job management screen 50 is switched to display the assigned steps. When the assigned steps are displayed, “assigned steps” is displayed on the switch button 50a. When the switch button 50a is pressed in this state, the display of the job management screen 50 is switched to the display of all steps.

For example, a worker can grasp the progress of the job including the assigned steps by displaying, as a list, the job management information on the jobs that are currently at the steps assigned to the worker. The administrator can grasp the progress status of each job related to the ordered print product by displaying the job management information on all steps in the form of a list. The administrator can watch over the entire progress status.

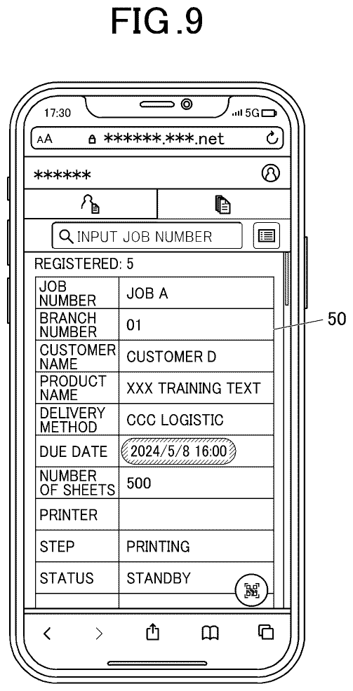

In a case where the terminal apparatus that has sent the request to display the job management screen 50 is a mobile terminal such as a smartphone, as illustrated in FIG. 9, the mobile version of the job management screen 50 may be displayed. In the job management screen 50 illustrated in FIG. 9, for example, only the job management information on the steps assigned to the logged-in user is displayed. Although only one piece of job management information is displayed in FIG. 9, information of other jobs can be displayed in response to a swiping operation in the vertical direction.

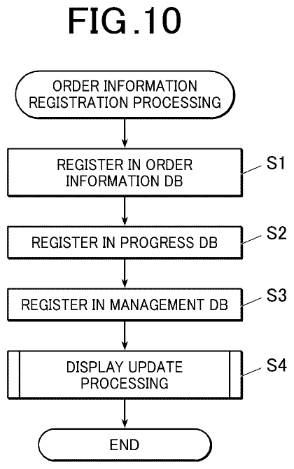

When order reception information is input (received) from the order reception terminal 2 via the communicator 13, the controller 11 executes order information registration processing illustrated in FIG. 10.

In the order information registration processing, first, the controller 11 adds a record to the order information DB 122, and registers the input order information in the order information DB 122 (step S1).

Next, the controller 11 adds a record to the progress DB 123, and registers, in the progress DB 123, the progress information of the job corresponding to the input order information (step S2).

For example, the controller 11 registers, in the record added to the progress DB 123, the job identification information (the job ID and the branch number), the assigned worker, the steps, the status, the registration date and time, and the like corresponding to the input order information. The first step (e.g., DTP) is registered as the step. “Standby” is registered as the status, for example. The “standby” is information indicating that the work for the step is executable.

Next, the controller 11 adds a record to the management DB 126, and registers the job management information corresponding to the input order information in the management DB 126 (step S3). For example, the controller 11 registers, in the record added to the management DB 126, job management information such as a job ID, a branch number, a customer name, a delivery method, a due date, the number of sheets to be printed, a job type, a step, and a status of the job corresponding to the input order information. The first step (e.g., DTP) is registered as the step. “Standby” is registered as the status, for example.

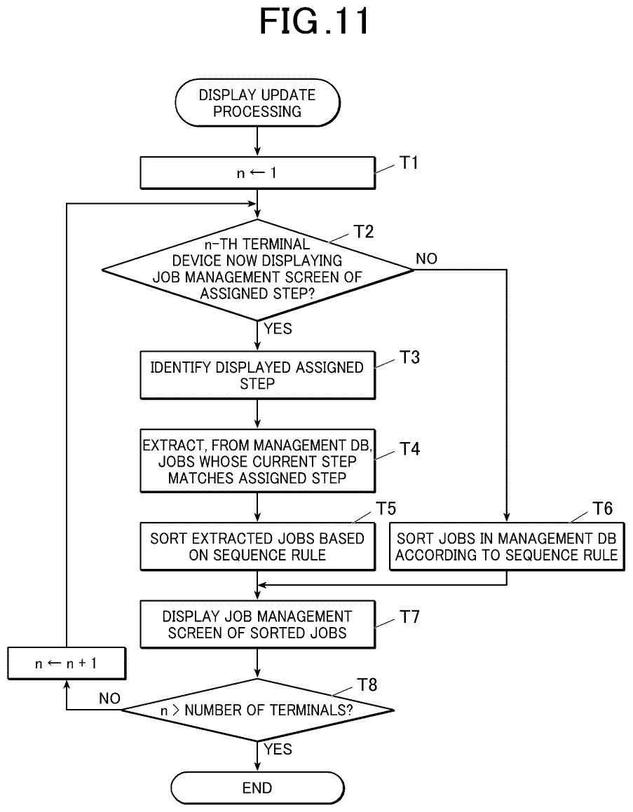

The controller 11 executes the display update processing shown in FIG. 11 (step S4), and ends the order information registration processing. The display update processing is a process of updating the job management screen 50.

Hereinafter, the display update processing will be described with reference to FIG. 11.

In the display update processing, first, the controller 11 sets a variable n to 1 (step T1).

Next, the controller 11 determines whether the job management screen 50 of the assigned step is being displayed on the n-th terminal among the terminals that are currently displaying the job management screen 50 (step T2).

When it is determined that the n-th terminal is displaying the job management screen 50 of the assigned step (step T2; YES), the controller 11 specifies the assigned step displayed on the n-th terminal (step T3).

For example, the controller 11 identifies the displayed assigned step based on the worker ID and the worker DB 125 of the logged-in user of the n-th terminal.

Next, the controller 11 extracts, from the management DB 126, job management information whose “step” item matches the identified assigned step (step T4). Thus, the job management information having the current step that matches the assigned step is extracted.

Next, the controller 11 sorts the extracted job management information according to the sequence rule corresponding to the attribute of the logged-in user (step T5).

To be more specific, when there is job management information whose status is “standby” in the extracted job management information, the controller 11 refers to the worker DB 125 and the sequence rule DB 124, and sorts the job management information in which the step is in “standby” in accordance with the sequence rule applied to the attribute of the logged-in user.

The controller 11 allows the n-th terminal to display the sorted job management screen 50 (step T7), and proceeds to step T8.

On the other hand, when it is determined that the n-th terminal is not displaying the job management screen 50 of the assigned step (step T2; NO), the controller 11 sorts the job management information stored in the management DB 126 according to the sequence rule corresponding to the attribute of the logged-in user (step T6). To be more specific, when job management information with a status of “standby” exists in the administrator DB 126, the controller 11 refers to the worker DB 125 and the sequence rule DB 124, and sorts the job management information with a status of “standby” according to the sequence rule corresponding to the attribute of the logged-in user with respect to each step. For an administrator or the like whose worker information is not registered in the worker DB 125, the controller 11 performs the sorting according to the sequence rule that is applied to everyone.

The controller 11 allows the n-th terminal to display the sorted job management screen 50 (step T7), and proceeds to step T8.

The job management information to be displayed on the job management screen 50 may be limited to information on a production target job, for example, a job in which the status of the packing step, which is the final step, is not completed.

In step T8, the controller 11 determines whether or not the variable n is greater than the number of terminals currently displaying the job management screen 50 (step T8).

When it is determined that the variable n is not greater than the number of terminals currently displaying the job management screen 50 (step T8; NO), the controller 11 increments the variable n (step T9). The controller 11 returns to step T2.

If it is determined that the variable n is greater than the number of terminals currently displaying the job management screen 50 (step T8; YES), the controller 11 ends the display update processing.

When the display update processing ends, the controller 11 ends the order information registration processing.

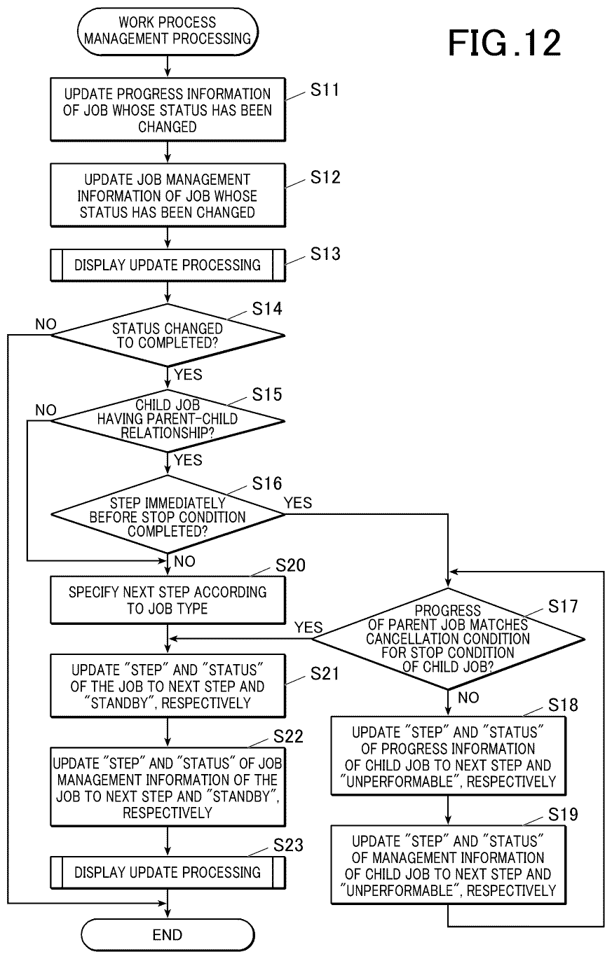

When status change information is input (received) from the worker terminal 3 via the communicator 13, the controller 11 executes the work step management processing illustrated in FIG. 12.

In this processing, when the progress status of the assigned step of a certain job changes, the worker inputs the change of the status on the job management screen 50 of the worker terminal 3. For example, when the status portion in the row of the job to be changed is selected (tapped) on the job management screen 50 of the worker terminal 3, status options are displayed as a pull-down menu. When a new status is selected from the displayed pull-down menu, the selected status is transmitted to the management server 1 as the status change information in association with the job ID, the branch number, and the step of the job management information, and the worker ID of the worker who input the new status.

In the present embodiment, a status change is input on the job management screen 50 by the above-described method, but the method of inputting a status change is not limited thereto. For example, the status may be automatically changed to the next status by allowing the worker terminal 3 to read a QR code (R) or the like representing information capable of specifying a job. Alternatively, the management server 1 may be connected to a device such as a printing machine, and the management server 1 may automatically acquire work execution information from the device to automatically change the status.

In the work step management processing, first, the controller 11 updates, based on the input status change information, the progress information of the job for which the status change has been input, in the progress DB 123 (step S11).

Next, based on the input status change information, the controller 11 updates the job management information of the job for which the status change has been input, in the management DB 126 (step S12).

Next, the controller 11 executes display update processing (step S13).

The display update processing executed in step S13 is the same as that described in step S4 of FIG. 10, and therefore, the description is omitted.

Next, the controller 11 determines, based on the input status change information, whether the status has been changed to completed (step S14).

If the controller 11 determines that the status has not been changed to completed (step S14; NO), the controller 11 ends the work step management processing.

If the controller 11 determines that the status has been changed to completed (step S14; YES), the controller 11 determines whether the job whose status has been changed is a child job defined by a parent-child relationship (step 15).

When it is determined that the job whose status has been changed is not a child job in the parent-child relationship (step 15; NO), the controller 11 proceeds to step S20.

When it is determined that the job whose status has been changed is a child job in the parent-child relationship (step 15; YES), the controller 11 determines whether or not the step immediately before the step with the stop condition defined by the parent-child relationship rule has been completed in the child job (step S16).

When it is determined that the step immediately before the step with the stop condition has not been completed in the child job (step S16; NO), the controller 11 proceeds to step S20.

When it is determined that the step immediately before the step with the stop condition has been completed in the child job (step S16; YES), the controller 11 determines whether the progress of the parent job matches the cancellation condition for the stop condition of the child job (step S17).

When it is determined that the progress of the parent job does not match the cancellation condition for the stop condition of the child job (step S17; NO), the controller 11 updates the “step” of the progress information of the child job in the progress DB 123 to the next step and the status to “unperformable” (step S18). The controller 11 updates the “step” and the status in the job management information of the child job in the management DB 126 to the next step and “unperformable”, respectively (step S19), and returns to step S17. That is, if the progress of the parent job does not match the cancellation condition for the child stop condition, the work progress can be controlled so as not to proceed to the next step.

When it is determined that the progress of the parent job matches the cancellation condition for the stop condition of the child job (step S17; YES), the controller 11 proceeds to step S21.

In step S20, the controller 11 identifies the next step of the job on the basis of the job type of the job for which the status change has been input (step S20).

The number of steps and the procedure for creating a print product vary depending on the job type. It is complicated for the administrator to manage the process flow. To cope with this, in the present embodiment, the controller 11 automatically specifies the next step of the completed step based on the job type. For example, the controller 11 specifies the type of the job based on the “job type” of the order information of the job in the order information DB 122. The controller 11 identifies the next step of the job based on the job type.

For example, when the job type is catalog, the steps are as follows.
DTP-proofreading-printing-bookbinding-processing-inspecting-packing

For example, when the job type is flyer, the steps are as follows.
DTP-proofreading-printing-inspection-packing

That is, the number of steps is larger in the case where the job type is catalog than in the case where the job type is leaflet.

The correspondence between job type and steps is stored in the storage section 12.

Next, the controller 11 updates the “step” and the status of the progress information of the job in the progress DB 123 to the next step and “standby”, respectively (step S21). The controller 11 updates the “step” of the job management information of the job in the management DB 126 to the next step, and the status to “standby” (step S22). The controller 11 executes display update processing (step S23), and ends the work step management processing.

The display update processing executed in step S23 is the same as that described in step S4 of FIG. 10, and therefore, the description is omitted.

Here, when the status of a certain step of a certain job is changed to completed, the next step is automatically specified in step S18 or step S20 of FIG. 12. In the display update processing in step S23, the next step is displayed as “step” of the job management information on the job management screen 50, and “standby”, which indicates the step is ready to be performed, is displayed as the “status”. In this step, job management information whose “step” and “status” are the same as those of the job is extracted from the management DB 126, and the extracted job management information is sorted and displayed according to a predetermined sequence rule. That is, the job management information in which the status of the next step is “standby” is sorted and displayed according to the predetermined sequence rule stored in the sequence rule DB 124.

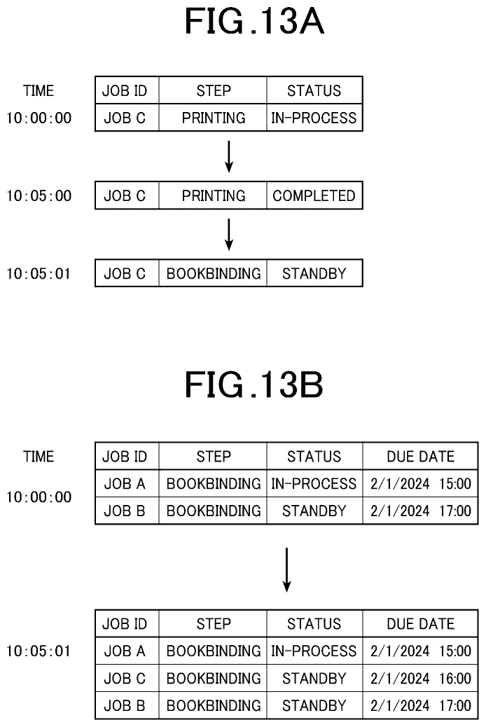

FIGS. 13A to 17B are diagrams illustrating changes in the displayed job management screen 50 in the above-described work step management processing. In FIGS. 13A to 17B, illustrated items are limited so that changes can be easily understood.

FIG. 13A is a diagram illustrating changes in the progress DB 123 for a job C whose job type is catalog, when the status of printing is changed to in-process at 10:00:00 and the status of printing is further changed to completed at 10:05:00. FIG. 13B is a diagram illustrating a change in the displayed job management screen 50 (assigned step) according to a change in the progress of the job C illustrated in the FIG. 13A. It is assumed that the applied sequence rule is “earlier due date”.

Regarding the job C, when the status of printing becomes in-process at 10:00:00 and then completed at 10:05:00, the progress of the job C is automatically changed to standby of the next step bookbinding and registered in the progress DB 123 at 10:05:01 in FIG. 13A. In the job management screen 50 for the bookbinding step, since the job C is in process of printing, the job C is not displayed at 10:00:00 as illustrated in FIG. 13B. When the progress of the job C is changed to standby for bookbinding at 10:05:01, the job C is displayed as standby for bookbinding on the job management screen 50 for bookbinding steps. Since the applied sequence rule is “earlier due date”, the job C is displayed above the job B which has already been in the standby state.

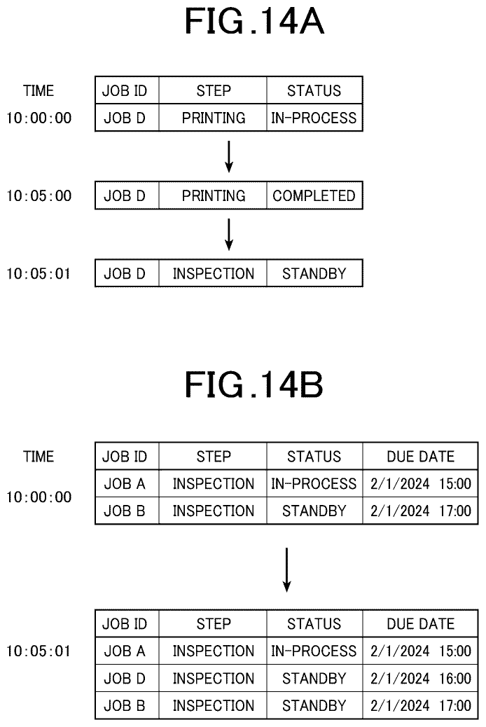

FIG. 14A is a diagram illustrating changes in the progress DB 123 for a job D whose job type is leaflet, when the status of printing has been changed to in-process at 10:00:00 and the status of printing has been further changed to completed at 10:05:00. FIG. 14B illustrates a change in the displayed job management screen 50 (inspection step) according to the change in the progress of the job D illustrated in FIG. 14A. It is assumed that the applied sequence rule is “earlier due date”.

Regarding the job D, when the printing becomes in process at 10:00:00 and then completed at 10:05:00, the progress of the job D is automatically changed to standby for the next step inspection and registered in the progress DB 123 as illustrated in FIG. 14A at 10:05:01. In the job management screen 50 of inspection steps, since the job D is in process of printing, the job D is not displayed at 10:00:00 as illustrated in FIG. 14B. When the progress of the job D is changed to standby for inspection at 10:05:01, the job D is displayed as standby for inspection on the job management screen 50 of the inspection steps. Since the applied sequence rule is “earlier due date”, the job D is displayed above the job B which has already been in the standby state.

As described above, in the work step management processing, when the completion of a certain step is input by the worker, the next step, which is predetermined corresponding to the job type, is automatically displayed on the job management screen 50 as standby (the step can be performed). For example, if the job type is catalog, bookbinding becomes standby after completion of printing. If the job type flyer, inspection becomes standby after completion of printing. Therefore, the worker for the next step can accurately grasp a job that is in an executable standby state. Since the jobs in the standby state are sorted and displayed on the basis of the predetermined sequence rule, the worker in the next step can accurately grasp the order of performing the jobs.

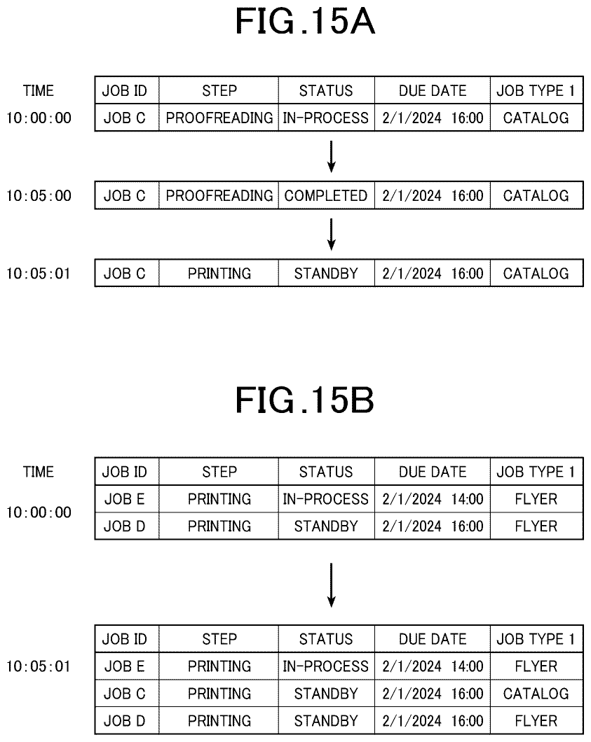

FIG. 15A is a diagram illustrating the changes in the progress DB 123 when the status of proofreading is changed to completed at 10:05:00 for a job C whose job type is catalog. FIG. 15B illustrates a change in the displayed job management screen 50 (printing step) according to the change in the progress of the job C illustrated in FIG. 15A. It is assumed that the applied sequence rule is “earlier due date”—“larger number of remaining steps”.

When the proofreading of the job C is completed at 10:05:00, the progress of the job C is automatically changed to standby for the next step printing as illustrated in FIG. 15A at 10:05:01 and registered in the progress DB 123. In the job management screen 50 for printing steps, as illustrated in the FIG. 15B, the job C is not displayed at the time point of 10:00:00 since the job C is in process of proofreading. When the progress of the job C is changed to standby for printing at 10:05:01, the job C is displayed as standby for printing on the job management screen 50 for printing steps. The applied sequence rule is “earlier due date”-“larger number of remaining steps”. The number of remaining steps is larger in catalog printing than in flyer printing. Therefore, the job C for producing a catalog is displayed above the job D for producing a flyer.

As described above, in the work step management processing, the order of performing jobs can be sorted according to a plurality of conditions such as due date and work volume, so that the worker can perform jobs in the order that meets the plurality of conditions.

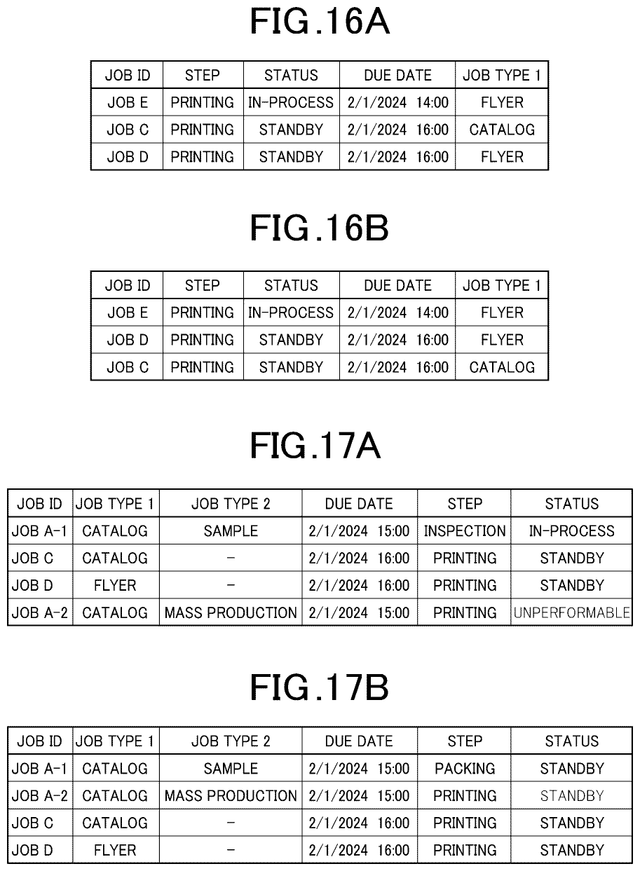

FIG. 16A illustrates the job management screen 50 (printing step) for an experienced worker when the status of proofreading is changed to completed for job C whose job type is catalog. FIG. 16B illustrates the change of the job management screen 50 (printing step) for a freshman worker when the status of proofreading is changed to completed for job C whose job type is catalog. It is assumed that the applied sequence rule is “earlier due date”-“larger number of remaining steps” when the target person is an experienced worker, and is “earlier due date”-“earlier arrival at step” when the target person is a freshman worker.

As shown in FIG. 16A, in the job management screen 50 for the experienced worker, the job C, which is printing catalog and has a large number of remaining steps, is displayed above the job D while the job C and job D have the same due date. On the other hand, in the job management screen 50 for the freshman worker, the job D, which arrived at the printing step earlier, is displayed above the job C, while the job C and job D have the same due date. In the case of the freshman worker, if the order of jobs is frequently changed, a mistake such as job mix-up may occur. To avoid this, the rule of displaying jobs with the same due date in the order of arrival can prevent mix-up errors.

In this way, in the work step management processing, the jobs can be sorted and displayed in the optimum order according to the experience and ability of the worker.

FIG. 17A illustrates the job management screen 50 of all steps for a job A-1 (parent) and a job A-2 (child) having a parent-child relationship, when the job a-1 is in the step of inspection. FIG. 17B illustrates the job management screen 50 of all steps when completion of the inspection of the job a-1 is input. It is assumed that the applied sequence rule is “earlier due date”. For the job A-1 and the job A-2, a parent-child relation rule is set in which printing of the child job cannot be started until inspection of the parent job is completed.

As shown in FIG. 17A, when the inspection of the job A-1 as the parent job is not completed, the job A-2 at the printing step is displayed as “unperformable”. When the inspection of the parent job is completed and the job becomes standby for packing, the job A-2 in the printing step becomes standby as shown in FIG. 17B.

In this way, in the work step management processing, the steps of the jobs having the parent-child relationship are managed and displayed according to the parent-child relationship rule, so that the worker can perform the jobs having the parent-child relationship in the order determined by the parent-child relationship rule.

When the controller 11 is notified that the aggregation button 50b of the job management screen 50 is pressed from the worker terminal 3 or the administrator terminal 4 via the communication section 13, the controller 11 displays the progress screen 51 with respect to each delivery company on the terminal from which the notification has been sent. The delivery company as used herein is a delivery company used for delivering the print product. The delivery company for each job is determined in the item “delivery method” of the order information DB 122.

That is, in response to notification of the aggregation button 50b (see FIG. 8A) having been pressed, the controller 11 performs aggregation based on the order information DB 122, the progress DB 123, and the like. Specifically, the controller 11 adds up, with respect to each delivery company, the number of accepted orders and the number of uncompleted orders for each of the jobs due today and the jobs due next day. The controller 11 can determine whether or not the job has been completed, for example, by determining whether or not the current step is the final step “packing” and the status is “completed”. The controller 11 adds up the number of unstarted jobs and the number of jobs in process for each process for each of the jobs due today and the jobs due next day, and displays the aggregated result with respect to each delivery company on the progress screen 51.

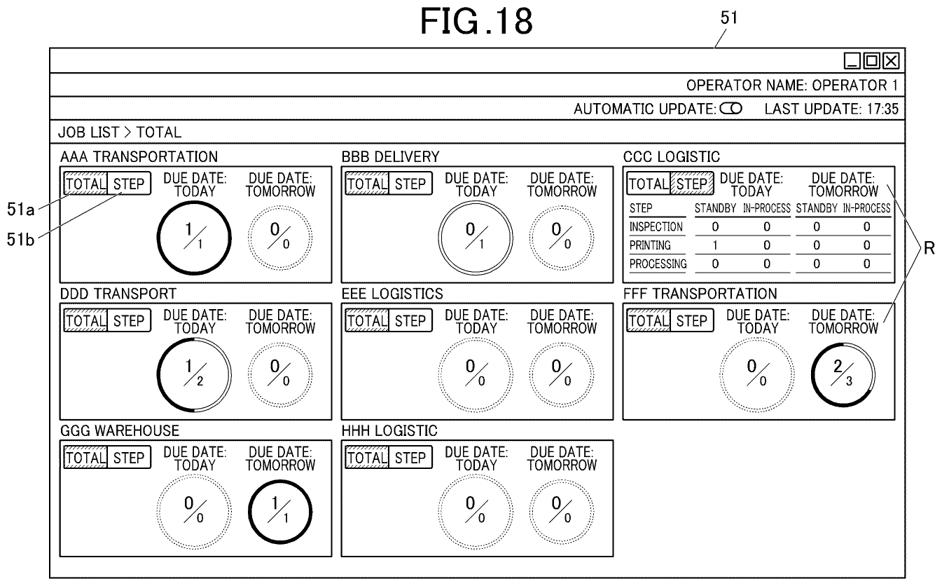

FIG. 18 is a view illustrating an example of the progress screen 51 with respect to each delivery company. As shown in FIG. 18, the progress screen 51 for each delivery company includes areas R for displaying the progress with respect to each delivery company. In each area R, a “total” button 51a and a “step” button 51b are provided. When the “total” button 51a is pressed, the number of received orders and the number of uncompleted orders for each of a job due today and a job due the next day that use the delivery company corresponding to the area R are displayed. When the “step” button 51b is pressed, the number of unstarted jobs and the number of in-process jobs are displayed with respect to each step and each of the jobs due today and the jobs due next day that use the delivery company corresponding to the area R.

In this way, it is possible to display the progress of the jobs with respect to each delivery company on the progress screen 51 with respect to each delivery company. This facilitates managing the progress of the jobs so that the jobs are completed by the time when the delivery companies collect the print product.

As described above, the controller 11 of the management server 1 displays, on the job management screen 50 of the worker terminal 3 or the administrator terminal 4, the name of the next step and that the next step is standby, with regard to the print job for which completion of the current step has been input. In this step, the controller 11 sorts the display order of the print jobs which are standby for the next step, based on the sequence rule registered in advance. The controller 11 displays the list of the job management screens 50 in the rearranged order.

Therefore, in each step of the print jobs, the worker can accurately grasp the jobs that are in a performable standby state and the order of performing the jobs.

For example, the controller 11 identifies the type of print product to be produced by the print job in which completion of the current step is input, and specifies the next step of the print job based on the identified type. The controller 11 displays, on the list displayed on the display part, the name of the specified next step and information indicating that the next step is performable.

Therefore, even in a case where the management of the process flow is complicated due to the fact that the steps are different depending on the type of print product, the worker for the next step can easily grasp the print jobs that can be performed.

For example, the controller 11 rearranges the display of the print jobs that can be performed in the next step based on the sequence rule constituted by a combination of a plurality of conditions. Therefore, the print jobs can be rearranged in a more efficient order to perform.

As the sequence rule, different rules are determined according to an attribute indicating the experience or ability of the worker. The controller 11 rearranges the display of the print jobs that can be performed in the next step on the basis of a sequence rule corresponding to the attribute of the worker referring to the list. Therefore, it is possible to display the list of the print jobs in the order that reflects the skill of the worker such as a freshman worker/experienced worker, and it is possible to reduce a work error of the worker in the next production step.

The controller 11 determines whether or not the print job in which completion of the current step is input is a child job having a parent-child relationship with another print job. When it is determined that the input job is a child job, the controller 11 displays the name of the next step of the print job and that the next step can be performable on the list displayed on the display part after the predetermined step of the other print job is completed.

Therefore, in a case where a certain step of the child job needs to be performed after a predetermined step of the parent job is completed, a worker does not need to manage the process, which can improve the efficiency of managing print jobs.

The description in the above embodiment is a preferred example of the present invention, and the present invention is not limited thereto.

Although an example in which a hard disk, a semiconductor nonvolatile memory, or the like is used as a computer-readable medium of the program according to the present invention has been disclosed in the above description, the present invention is not limited to this example. As another computer-readable medium, a portable recording medium such as a CD-ROM can be applied. A carrier wave is also applied as a medium for providing data of the program according to the present invention via a communication line.

Besides, the detailed configuration and the detailed operation of the printing job management system can be appropriately modified without departing from the spirit and scope of the present invention.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-094795 filed on Jun. 8, 2023 is incorporated herein by reference in its entirety.

What is claimed is:

1. A non-transitory computer-readable recording medium storing a printing job management program for causing a computer to manage print jobs related to ordered print products, wherein
the program causes the computer to execute:
a first step of displaying a plurality of print jobs under management on a display part in a form of a list including a current step of each print job;
a second step of displaying on the list displayed in the display part, in response to completion of a current step of a print job being input, a name of a next step of the print job and a state that the next step is performable; and
a third step of rearranging display of the print job in which the next step is performable based on a print job sequence rule that is registered in advance.

2. The recording medium according to claim 1,
wherein the second step includes identifying a type of a print product to be produced in the print job for which the completion of the current step has been input; specifying the next step of the print job based on the identified type; and displaying on the list displayed in the display part the next step and the state that the next step is performable.

3. The recording medium according to claim 1, wherein the print job sequence rule is composed of a combination of a plurality of conditions.

4. The recording medium according to claim 1, wherein
the print job sequence rule varies depending on an attribute representing experience or ability of a worker, and
the third step includes rearranging the display of the print job in which the next step is performable, based on the print job sequence rule that corresponds to the attribute of the worker who refers to the list.

5. The recording medium according to claim 1, wherein
the second step includes determining whether the print job for which the completion of the current step has been input is a child job having a parent-child relationship with another print job; and in response to the print job being a child job, displaying on the list displayed in the display part the name of the next step of the print job and the state that the next step is performable after a predetermined step of the other print job is completed.

6. A print job management system, comprising: a server that manages a print job related to an ordered print product; and a terminal device that is connected to the server, wherein
the server:
causes a terminal device to display a plurality of print jobs under management in a form of a list including a current step of each print job;
in response to receiving an input of completion of a current step of a print job from the terminal device, displays on the list displayed on the terminal device a name of a next step of the print job and a state that the next step is performable; and
rearranges display of the print job in which the next step is performable based on a print job sequence rule that determines an order of performing print jobs and is registered in advance.

7. A print job managing method for causing a computer to manage print jobs related to ordered print products, wherein
the method causes the computer to execute:
displaying a plurality of print jobs under management on a display part in a form of a list including a current step of each print job;
displaying on the list displayed in the display part, in response to completion of a current step of a print job being input, a name of a next step of the print job and a state that the next step is performable; and
rearranging display of the print job in which the next step is performable based on a print job sequence rule that determines an order of performing print jobs and is registered in advance.
